(19) United States
(12) Patent Application Publication
(10) Pub. No.: US 2025/0381688 A1
(43) Pub. Date: Dec. 18, 2025

(54) ELECTRIC SHAVER

(71) Applicant: EveryMarket Inc, O'Fallon, MO (US)

(72) Inventor: Xiaowei Kang, Saint Louis, MO (US)

(21) Appl. No.: 18/741,144

(22) Filed: Jun. 12, 2024

(51) Int. Cl. B26B 19/38; B26B 19/14

(52) U.S. Cl. CPC B26B 19/386; B26B 19/145

(57) ABSTRACT

An electric shaver comprising a shaver handle comprising a shaver handle connection portion and a shaver head. The shaver head has a shaver head connection portion configured to rotationally couple to the shaver handle connection portion, a shaver head body, and a plurality of razors rotationally coupled to the shaver head connection portion. The shaver handle connection portion is configured to rotate the shaver head connection portion, which in turn, is configured to rotate the plurality of razors. The plurality of razors are configured to rotate simultaneously in unison and are configured to move independently with respect to the shaver head body in a direction toward and away from the shaver head body.

### TECHNICAL FIELD

The present disclosure relates generally to an electric shaver.

### BACKGROUND

An electric shaver is a razor with an electrically powered rotating or oscillating blade. Electric shavers remove hair from the skin of the user. Electric shavers may be rotary-style shavers such that the razors rotate in place about an axis.

### BRIEF SUMMARY

An electric shaver includes a shaver handle comprising a shaver handle connection portion and a shaver head. The shaver head includes a shaver head connection portion configured to rotationally couple to the shaver handle connection portion, a shaver head body, and a plurality of razors rotationally coupled to the shaver head connection portion. The shaver handle connection portion is configured to rotate the shaver head connection portion, which in turn, is configured to rotate the plurality of razors. The plurality of razors are configured to rotate simultaneously in unison and are configured to move independently with respect to the shaver head body in a direction toward and away from the shaver head body.

A shaver head for an electric shaver has a shaver head body, a single, central razor, a plurality of perimeter razors rotationally coupled to the single, central razor, and a frame configured to allow each of the perimeter razors of the plurality of perimeter razors to move independently with respect to the shaver head body in a direction toward and away from the shaver head body.

### BRIEF DESCRIPTION OF THE DRAWINGS

Features and advantages will be apparent from the following, more particular, description of various exemplary embodiments, as illustrated in the accompanying drawings, wherein like reference numbers generally indicate identical, functionally similar, and/or structurally similar elements.

FIG. 1 illustrates a perspective view of an electric shaver, according to an embodiment of the present disclosure.

FIG. 2 illustrates a front perspective view of a shaver head of the electric shaver of FIG. 1, according to an embodiment of the present disclosure.

FIG. 3 illustrates a rear perspective view of the shaver head of FIG. 2, according to the present disclosure.

FIG. 4 is a rear view of the shaver head of FIG. 2, according to the present disclosure.

FIG. 5 is a top view of a first body portion of the shaver head of FIG. 2, with a second body portion of the shaver head omitted, according to the present disclosure.

FIG. 6A is a top view of the second body portion of the shaver head of FIG. 2, with the first body portion of the shaver head omitted, according to the present disclosure.

FIG. 6B is a side view of the second body portion of FIG. 6A, according to the present disclosure.

FIG. 7 is a front view of a shaver handle of the electric shaver of FIG. 1, according to the present disclosure.

FIG. 8 is a rear perspective view of the shaver handle of FIG. 7, according to the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first” and “second,” and the like, may be used interchangeably to distinguish one component from another and are not intended to signify location or importance of the individual components.

The singular forms “a,” “an,” and “the” include plural references unless the context clearly dictates otherwise.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides an electric shaver having a plurality of independently moveable razors. The razors are housed within a single housing (e.g., the first body portion described to follow), but move independently of one another. The razors of the present disclosure are each provided with a first frame and lever arms that allow the respect razor to be moveable with respect to a second frame in a direction into and out of the single housing.

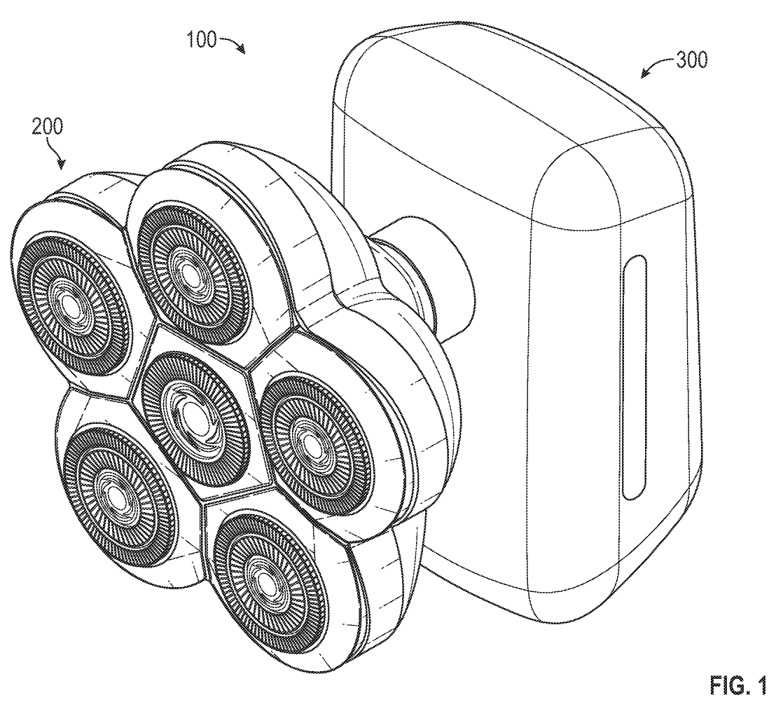

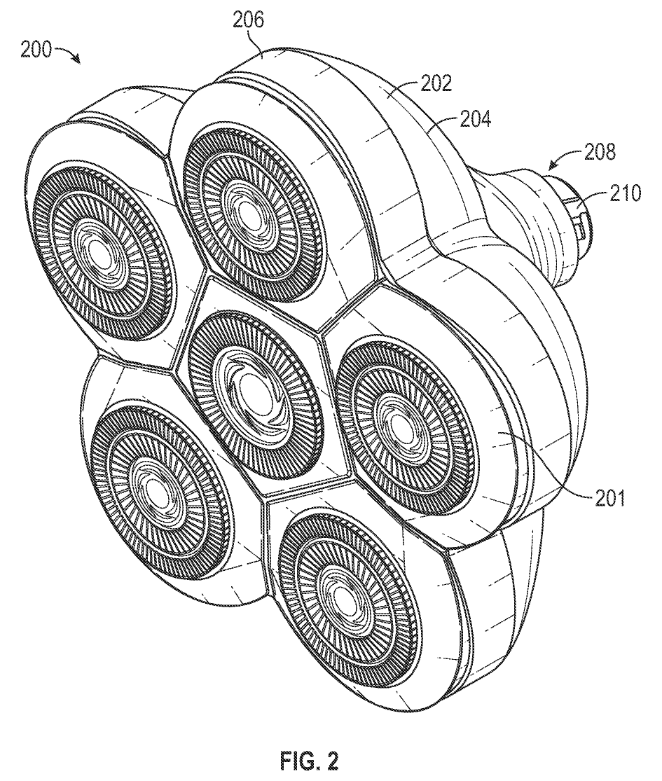

With reference now to the figures, an electric shaver with the aforementioned benefits is described in more detail. FIG. 1 illustrates an electric shaver 100 having a shaver head 200 and a shaver handle 300. Turning first to FIGS. 2 to 4, the shaver head 200 is illustrated in a forward perspective view. The shaver head 200 includes a shaver head body 202 having a first body portion 204 and a second body portion 206. The first body portion 204 and the second body portion 206 are coupled together as discussed in more detail to follow.

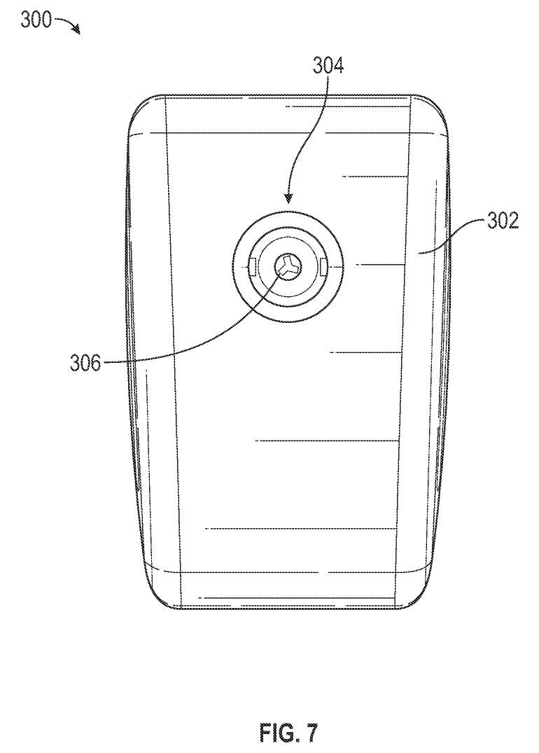

The first body portion 204 includes a shaver head connection portion 208 for coupling the shaver head 200 to the shaver handle 300. The shaver head connection portion 208 includes a first slot 210 and a second slot 212 for coupling to respective protrusions on the shaver handle connection portion 304 (FIG. 7). The shaver head connection portion 208 includes a shaver head shaft 214 for coupling to a shaver handle opening 306 (FIG. 7). The shaver head connection portion 208 couples the shaver head 200 to the shaver handle 300. The connection between the shaver head shaft 214 and the shaver handle opening 306 (FIG. 7) allows for rotational power to be transferred from the shaver handle 300 to the razors 201 of the shaver head 200, as described in more detail to follow.

The second body portion 206 includes a plurality of circular razors 201. FIG. 2 illustrates six razors, however, more or fewer may be provided. Each razor 201 of the plurality of razors 201 rotates around its own axis, and is independently depressible with respect to the remaining razors 201.

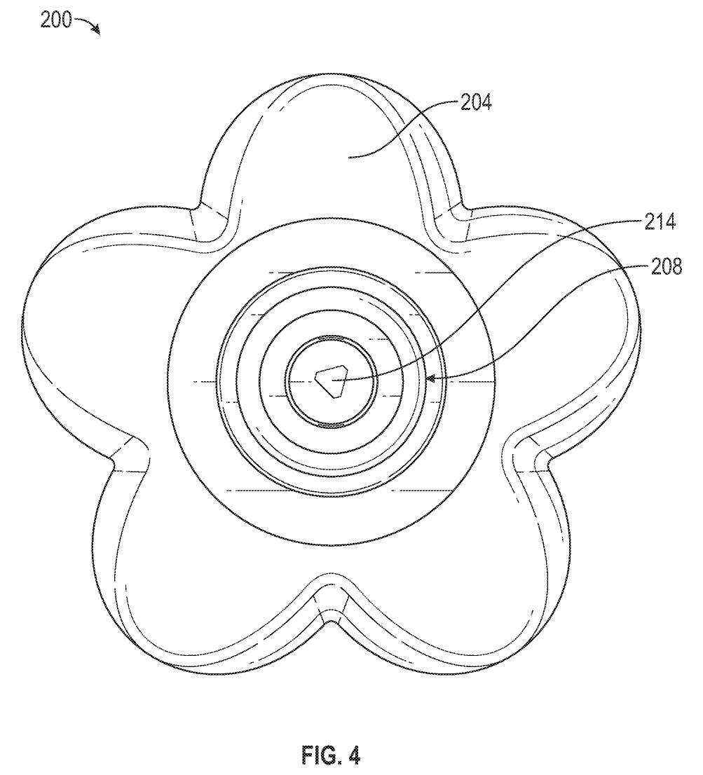

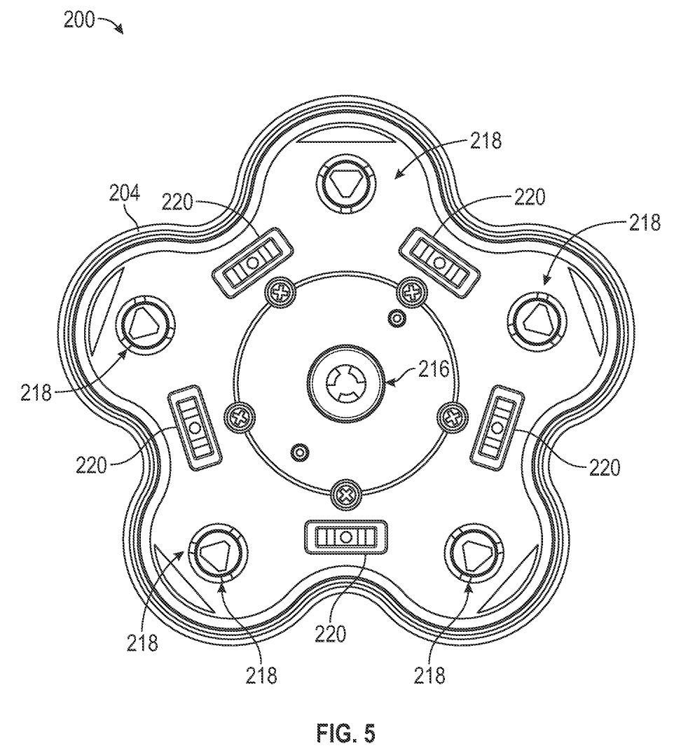

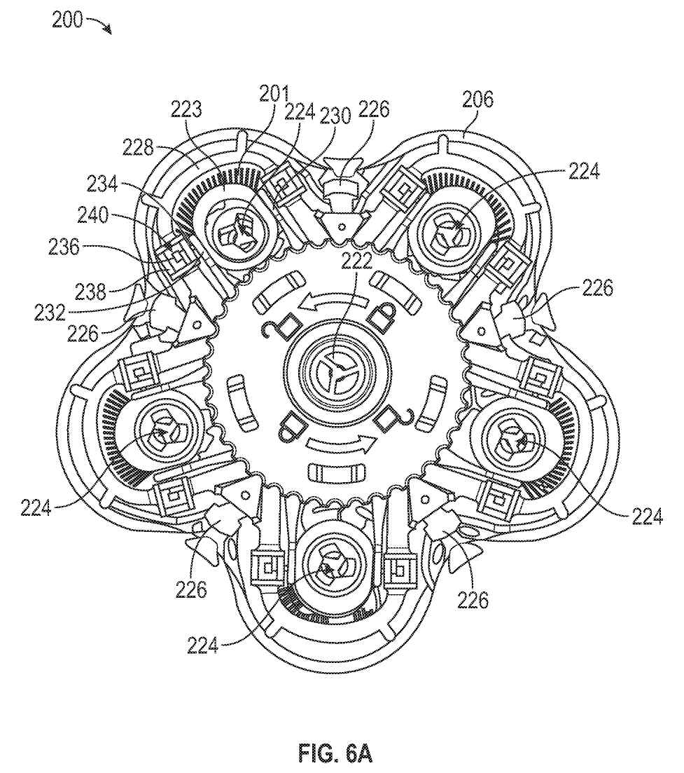

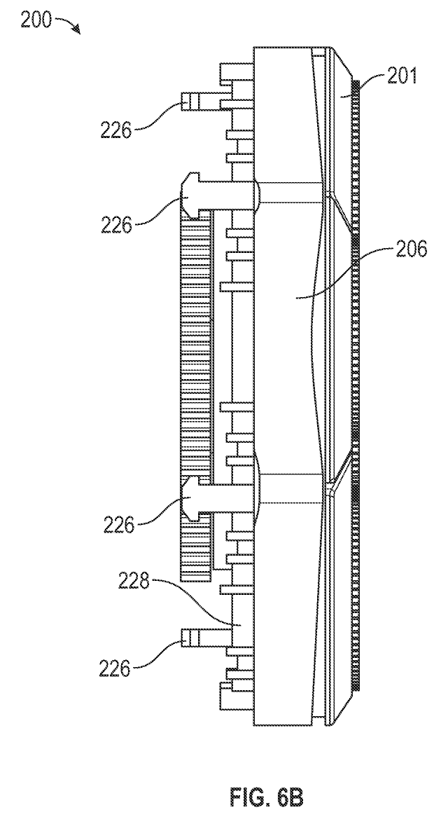

As noted, the first body portion 204 and the second body portion 206 are connected together. FIGS. 5, 6A, and 6B illustrate the internal features of the shaver head body 202. In FIG. 5, the view is of the inside of the first body portion 204. That is, FIG. 5 illustrates the opposing view of FIG. 4 with the second body portion 206 removed (e.g., if one were to remove the second body portion 206 in FIG. 2 and view the first body portion 204 with the second body portion 206 removed, the view would illustrate the components shown in FIG. 5). The first body portion 204 includes a first rotating shaft 216. The first rotating shaft 216 is coaxial with and rotationally coupled to the shaver head shaft 214. That is, viewing FIGS. 4 and 5, the shafts 216 and 214 are aligned. In this manner, when the shaver head shaft 214 is rotated, the first rotating shaft 216 is also rotated. The first body portion 204 includes a plurality of second rotating shafts 218. The plurality of second rotating shafts 218 are coupled to the first rotating shaft 216 such that they rotate together. Each second rotating shaft 218 aligns with a razor 201. Accordingly, when the second rotating shafts 218 rotate, the respective razor 201 rotates. In use, the shaver head shaft 214 is rotated (by the motor of the shaver handle 300, as described to follow), which in turn rotates the first rotating shaft 216 and the rotationally coupled second rotating shafts 218, which, therefore, rotates the razors 201. The first body portion 204 includes a plurality of first body portion slots 220. Each first body portion slot 220 aligns with a respective second body portion protrusion 226 (FIG. 6B) on the second body portion 206. The first body portion slots 220 and protrusions 226 couple the first body portion 204 to the second body portion 206 and prevent relative motion therebetween.

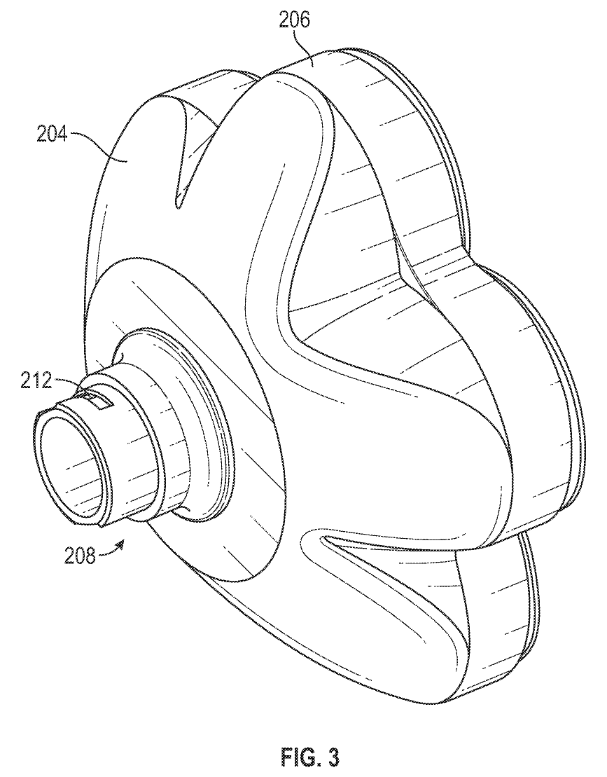

In FIG. 6A, the view is of the inside of the second body portion 206 and in FIG. 6B, the view is a side view showing both the second body portion 206 and the internal portions that extend therefrom (and, thus, into the first body portion 204 when coupled together). That is, FIG. 6A illustrates the view of FIG. 4, but with the first body portion 204 removed (e.g., if one were to remove the first body portion 204 in FIG. 3 and view the second body portion 206 with the first body portion 204 removed, the view would illustrate the components shown in FIG. 6A). The second body portion 206 includes a first opening 222. The first opening 222 is coupled to an opposing side of one of the razors 201 (in this case, the central razor 201 illustrated in FIG. 1). The first opening 222 receives the first rotating shaft 216 (FIG. 5). In this manner, when the first rotating shaft 216 is rotated by the shaver handle 300, the razor 201 rotates. For each razor 201 around the perimeter of the second body portion 206, the second body portion 206 includes a first frame 223 having a second opening 224 therein. The first frame 223 is coupled to an underside of the razor 201 (e.g., the side visible in FIG. 6A, which is the opposing side of the visible side in FIG. 1). Each second opening 224 receives a respective second rotating shaft 218 of the plurality of second rotating shafts 218. Accordingly, when the second rotating shafts 218 are rotated by the shaver handle 300, the respective razors 201 rotate. Since the first rotating shaft 216 rotates in unison with the plurality of second rotating shafts 218, all of the razors 201 also rotate in unison.

With continued reference to FIG. 6A, the first frame 223 includes two extensions 234, the extensions 234 extend from opposing sides of the first frame 223. At the end of each extension is a protrusion 236. The second body portion 206 includes a second frame 228. The second frame 228 extends around the perimeter of the second body portion 206 as illustrated in FIG. 6A. The second frame 228 surrounds each first frame 223 and razor 201 in a generally U-shaped manner. Each U-Shaped portion is coupled to or integral with a central circular portion (not visible) such that all five U-shaped portions of the second frame 228 extend from the central circular portion. The second frame 228 includes two guides 238, each guide 238 having an opening 240 therein. The guides 238 and openings 240 are on opposing sides of the first frame 223 such that the openings 240 align with and receive the protrusions 236.

Between the first frame 223 and the second frame 228 are two lever arms 230, 232. The lever arms include a first lever arm 230 and a second lever arm 232. The lever arms 230, 232 are disposed on opposite sides of the second opening 224. A first end of each lever arm 230, 232 is fixedly and unmovably attached to the central circular portion of the second frame 228. A second end of each lever arm 230, 232 is fixedly and unmovably attached to the extensions 234. The lever arms 230, 232 support the razors 201 on the central circular portion of the second frame 228. The lever arms 230, 232 are formed of a flexible material, such as a thin metal, such that the lever arms 230, 232 may deform and return to their original state repeatedly.

The lever arms 230, 232 allow the razors to move relative to the second body portion 206. That is, when a force is exerted on the top surface (e.g., the surface visible in FIG. 1) of the razor 201, the extensions 234 move relative to the second frame 228 (e.g., the protrusions 236 move farther into the openings 240, out of the page as viewed in FIG. 6A). The second end of the two lever arms 230, 232 moves with the extensions 234, while the first end of the two lever arms 230, 232 remain stationary. In this manner, the lever arms 230, 232 depress with the force on the razor 201. When the force is removed from the razor 201, the lever arms 230, 232 propel the extensions 234, and thus also the razors 201, back to their original position.

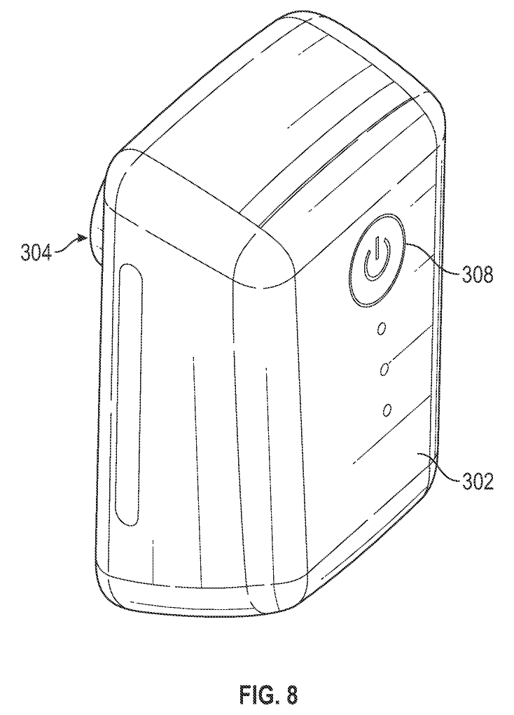

FIGS. 7 and 8 illustrate the shaver handle 300. The shaver handle 300 includes a shaver handle body 302, a shaver handle connection portion 304, and a power button 308. The shaver handle 300 couples to the shaver head 200 via the shaver handle connection portion 304. The shaver handle connection portion 304 includes a shaver handle opening 306. The shaver handle opening 306 receives the shaver head shaft 214. The shaver handle body 302 houses a motor (not visible).

In use, and referring to FIGS. 1 to 8, the power button 308 is actuated to turn on the motor. The motor spins the shaver head shaft 214 that is connected to a motor shaft (not visible) through the shaver handle opening 306. The motor rotates the shaver head shaft 214. In turn, the shaver head shaft 214 rotates the first rotating shaft 216, which is coupled to the plurality of second rotating shafts 218, thus rotating the plurality of second rotating shafts 218 in unison with the first rotating shaft. Since the rotating shafts 216, 218 are coupled to the razors 201, each of the razors 201 rotate in unison.

Accordingly, the electric shaver 100 provides a plurality of razors 201 housed within a solid, unmovable body 202, but with the ability for the razors 201 to move with respect to the body 202. The solid, unmovable body 202 is formed of two portions, the first body portion 204 and the second body portion 206. When viewing FIG. 2, for example, each of the razors 201 is independently moveable within the second body portion 206. For example, each razor 201 is independently depressible (e.g., movable in a direction toward the body 202). This independent movement is achieved by the first frame 223 and the lever arms 230, 232 discussed previously. The independent movement allows the shaver head 200 to provide coverage to a contoured surface (such as a user’s face) because each razor 201 is allowed to move independent of the other razors 201.

Further aspects are provided by the subject matter of the following clauses.

An electric shaver comprising: a shaver handle comprising a shaver handle connection portion; and a shaver head, the shaver head comprising: a shaver head connection portion configured to rotationally couple to the shaver handle connection portion; a shaver head body; and a plurality of razors rotationally coupled to the shaver head connection portion, wherein, the shaver handle connection portion is configured to rotate the shaver head connection portion, which in turn, is configured to rotate the plurality of razors, and wherein, the plurality of razors are configured to rotate simultaneously in unison and are configured to move independently with respect to the shaver head body in a direction toward and away from the shaver head body.

The electric shaver of the preceding clause, the shaver handle comprising a shaver handle body housing a motor, the motor configured to rotate the shaver head connection portion.

The electric shaver of any preceding clause, the shaver head body comprising a first body portion and a second body portion fixedly connected to the first body portion.

The electric shaver of any preceding clause, wherein the first body portion comprises a plurality of first body portion slots and the second body portion comprises a plurality of second body portion protrusions configured to be received in the plurality of first body portion slots to fixedly connect the second body portion to the first body portion.

The electric shaver of any preceding clause, the first body portion housing the shaver head connection portion and the second body portion housing the plurality of razors.

The electric shaver of any preceding clause, wherein the shaver head connection portion extends from a first side of the first body portion, the shaver head comprising a first rotating shaft extending from a second side of the first body portion that opposes the first side, wherein the first rotating shaft is rotationally coupled to the shaver head connection portion such that rotation of the shaver head connection portion simultaneously rotates the first rotating shaft.

The electric shaver of any preceding clause, the shaver head comprising a plurality of second rotating shafts that rotate simultaneously with the first rotating shaft, wherein each of the first rotating shaft and the plurality of second rotating shafts are coupled to a respective razor of the plurality of razors.

The electric shaver of any preceding clause, wherein the razors comprise a single central razor and a plurality of perimeter razors circumferentially spaced around the single central razor.

The electric shaver of any preceding clause, wherein the single central razor is aligned with the shaver head connection portion such that rotation of the shaver head connection portion causes rotation of the single central razor.

The electric shaver of any preceding clause, wherein for each perimeter razor of the plurality of perimeter razors, the shaver head comprises: a first frame; and two lever arms disposed on opposing sides of the first frame.

The electric shaver of any preceding clause, the shaver head comprising a second frame having a central circular portion and a plurality of U-shaped portions extending from the central circular portion, wherein each U-shaped portion aligns with each perimeter razor of the plurality of perimeter razors.

The electric shaver of any preceding clause, wherein a first end of each of the two lever arms are fixedly connected to the central circular portion and a second end of each of the two lever arms is fixedly connected to the first frame.

The electric shaver of any preceding clause, wherein the first frame and the lever arms are configured to permit the perimeter razors to move independently with respect to the shaver head body in the direction toward and away from the shaver head body.

A shaver head for an electric shaver, the shaver head having: a shaver head body; a single, central razor; a plurality of perimeter razors rotationally coupled to the single, central razor; and a frame configured to allow each of the perimeter razors of the plurality of perimeter razors to move independently with respect to the shaver head body in a direction toward and away from the shaver head body.

The shaver head of the preceding clause, wherein each perimeter razor comprises: a first frame; and two lever arms disposed on opposing sides of the first frame.

The shaver head of any preceding clause, the shaver head comprising a second frame having a central circular portion and a plurality of U-shaped portions extending from the central circular portion, wherein each U-shaped portion aligns with each first frame.

The shaver head of any preceding clause, wherein a first end of each of the two lever arms are fixedly connected to the central circular portion and a second end of each of the two lever arms is fixedly connected to the first frame.

The shaver head of any preceding clause, wherein the first frame and the lever arms are configured to permit the perimeter razors to move independently with respect to the shaver head body in the direction toward and away from the shaver head body.

The shaver head of any preceding clause, wherein the shaver head body comprises a first body portion and a second body portion fixedly connected to the first body portion.

The shaver head of any preceding clause, wherein the first body portion comprises a plurality of first body portion slots and the second body portion comprises a plurality of second body portion protrusions configured to be received in the plurality of first body portion slots to fixedly connect the second body portion to the first body portion.

Although the foregoing description is directed to the preferred embodiments of the present disclosure, other variations and modifications will be apparent to those skilled in the art and may be made without departing from the scope of the disclosure. Moreover, features described in connection with one embodiment of the present disclosure may be used in conjunction with other embodiments, even if not explicitly stated above.

1. An electric shaver comprising:
a shaver handle comprising a shaver handle connection portion; and
a shaver head, the shaver head comprising:
a shaver head connection portion configured to rotationally couple to the shaver handle connection portion;
a shaver head body; and
a plurality of razors rotationally coupled to the shaver head connection portion,
wherein, the shaver handle connection portion is configured to rotate the shaver head connection portion, which in turn, is configured to rotate the plurality of razors, and
wherein, the plurality of razors are configured to rotate simultaneously in unison and are configured to move independently with respect to the shaver head body in a direction toward and away from the shaver head body.

2. The electric shaver of claim 1, the shaver handle comprising a shaver handle body housing a motor, the motor configured to rotate the shaver head connection portion.

3. The electric shaver of claim 1, the shaver head body comprising a first body portion and a second body portion fixedly connected to the first body portion.

4. The electric shaver of claim 3, wherein the first body portion comprises a plurality of first body portion slots and the second body portion comprises a plurality of second body portion protrusions configured to be received in the plurality of first body portion slots to fixedly connect the second body portion to the first body portion.

5. The electric shaver of claim 3, the first body portion housing the shaver head connection portion and the second body portion housing the plurality of razors.

6. The electric shaver of claim 5, wherein the shaver head connection portion extends from a first side of the first body portion, the shaver head comprising a first rotating shaft extending from a second side of the first body portion that opposes the first side, wherein the first rotating shaft is rotationally coupled to the shaver head connection portion such that rotation of the shaver head connection portion simultaneously rotates the first rotating shaft.

7. The electric shaver of claim 6, the shaver head comprising a plurality of second rotating shafts that rotate simultaneously with the first rotating shaft, wherein each of the first rotating shaft and the plurality of second rotating shafts are coupled to a respective razor of the plurality of razors.

8. The electric shaver of claim 1, wherein the razors comprise a single central razor and a plurality of perimeter razors circumferentially spaced around the single central razor.

9. The electric shaver of claim 8, wherein the single central razor is aligned with the shaver head connection portion such that rotation of the shaver head connection portion causes rotation of the single central razor.

10. The electric shaver of claim 8, wherein for each perimeter razor of the plurality of perimeter razors, the shaver head comprises:
a first frame; and
two lever arms disposed on opposing sides of the first frame.

11. The electric shaver of claim 10, the shaver head comprising a second frame having a central circular portion and a plurality of U-shaped portions extending from the central circular portion, wherein each U-shaped portion aligns with each perimeter razor of the plurality of perimeter razors.

12. The electric shaver of claim 11, wherein a first end of each of the two lever arms are fixedly connected to the central circular portion and a second end of each of the two lever arms is fixedly connected to the first frame.

13. The electric shaver of claim 12, wherein the first frame and the lever arms are configured to permit the perimeter razors to move independently with respect to the shaver head body in the direction toward and away from the shaver head body.

14. A shaver head for an electric shaver, the shaver head having:
a shaver head body;
a single, central razor;
a plurality of perimeter razors rotationally coupled to the single, central razor; and
a frame configured to allow each of the perimeter razors of the plurality of perimeter razors to move independently with respect to the shaver head body in a direction toward and away from the shaver head body.

15. The shaver head of claim 14, wherein each perimeter razor comprises:
a first frame; and
two lever arms disposed on opposing sides of the first frame.

16. The shaver head of claim 15, the shaver head comprising a second frame having a central circular portion and a plurality of U-shaped portions extending from the central circular portion, wherein each U-shaped portion aligns with each first frame.

17. The shaver head of claim 16, wherein a first end of each of the two lever arms are fixedly connected to the central circular portion and a second end of each of the two lever arms is fixedly connected to the first frame.

18. The shaver head of claim 17, wherein the first frame and the lever arms are configured to permit the perimeter razors to move independently with respect to the shaver head body in the direction toward and away from the shaver head body.

19. The shaver head of claim 14, wherein the shaver head body comprises a first body portion and a second body portion fixedly connected to the first body portion.

20. The shaver head of claim 19, wherein the first body portion comprises a plurality of first body portion slots and the second body portion comprises a plurality of second body portion protrusions configured to be received in the plurality of first body portion slots to fixedly connect the second body portion to the first body portion.
